(19) United States
(12) Patent Application Publication
(10) Pub. No.: US 2008/0011139 A1
(43) Pub. Date: Jan. 17, 2008

(54) Curved rule

(76) Inventor: Byoung-Young Song, Old Tappan, NJ (US)

Correspondence Address: F. CHAU & ASSOCIATES, LLC, 130 WOODBURY ROAD, WOODBURY, NY, 11797, US

(21) Appl. No.: 11/484,953

(22) Filed: Jul. 12, 2006

(51) Int. Cl. B26D 1/56

(52) U.S. Cl. 83/346; 76/107.8

(57) ABSTRACT

A curved rule of a rotary cutting die includes a cutting edge, a backside edge opposite the cutting edge, and a plurality of markings disposed on a side of the curved rule.

### BACKGROUND OF THE INVENTION

1. Field of the Invention

The present disclosure relates to rotary cutting dies, and more particularly to a curved rule for use with a rotary cutting die.

2. Description of Related Art

Curved rule is used together with a rotary cutting die in the manufacture of packaging, including boxes, labels, etc., made from plastics, fabrics, foils, foams, and the like. Referring to FIG. 1, a rotary cutting die includes a cylindrical die 101, a curved rule 102 coupled to the cylindrical die 101 by, for example, a die board, and an anvil drum 103, which is disposed opposite the cylindrical die 101.

Sheets of material can be fed through a rotary cutting die (in the direction of arrows 104), between the cylindrical die 101, including the curved rule 102, and the anvil drum 103.

The depth of a cut in the material can be controlled by a distance between the anvil drum 103 and the cylindrical die 101. Thus cuts, perforations, etc. can be formed in the material. Material can be processed at high rates of speed.

In high volume applications, the curved rule 102 can wear out and need replacing. Thus, the curved rule 102 represents a recurring cost to the manufacturer.

The curved rule 102 is cut from a spool of curved rule stock having an arc substantially matching that of the cylindrical die 101. That is the curved rule 102 has a specified circumference, and pitch circle for serrated rule. The spool of curved rule stock may be bent into a desired configuration and cut to a desired length prior to attaching the curved rule 102 to the cylindrical die 101.

Referring to FIG. 2, the curved rule 102 includes relief notches 201 in a backside 202, opposite a cutting surface 203. The notches 201 have known distances there between and facilitate fast measurement of the curved rule 102. The notches 201 add cost to the manufacture of the curved rule 102.

These pre-notched curved rules have been a popular choice for the ease of manual bending and flexibility for insertion in the die board. With the advancement of automatic bending machines however, these pre-notched rules can be difficult to bend consistently and are prone to jamming the bending machine.

Therefore, a need exists for a no-notch curved rule having a reference pattern marked thereon.

### SUMMARY OF THE INVENTION

According to an embodiment of the present disclosure, a curved rule of a rotary cutting die includes a cutting edge, a backside edge opposite the cutting edge, and a plurality of markings disposed on a side of the curved rule.

The plurality of markings are disposed on a side of the curved rule. The plurality of markings are disposed on the backside of the curved rule.

The plurality of markings are printed on the curved rule. The plurality of markings are scored on the curved rule.

The plurality of markings are disposed in a known pattern.

The backside comprises a continuous length with no notches.

According to an embodiment of the present disclosure, a method of manufacturing a curved rule stock, includes providing a rule stock, marking a side of the rule stock with a reference pattern to form a marked rule stock, and curving the marked rule stock to form the curved rule stock.

Marking comprises scoring the side of the rule stock. Marking comprises printing a pattern on the side of the rule stock.

The method includes bending the marked curved rule stock. The method includes cutting the marked curved rule stock to form the curved rule for attachment to a die board, wherein the marked curved rule stock is not notched.

### BRIEF DESCRIPTION OF THE DRAWINGS

Preferred embodiments of the present invention will be described below in more detail, with reference to the accompanying drawings:

FIG. 1 is an illustration of a rotary cutting die;

FIG. 2 is an illustration of a curved rule;

FIG. 3 is an illustration of a curved rule according to embodiments of the present disclosure;

FIG. 4 is an illustration of a curved rule according to embodiments of the present disclosure;

FIG. 5 is an illustration of a curved rule according to embodiments of the present disclosure; and

FIGS. 6A-B are flow charts of methods according to an embodiment of the present disclosure.

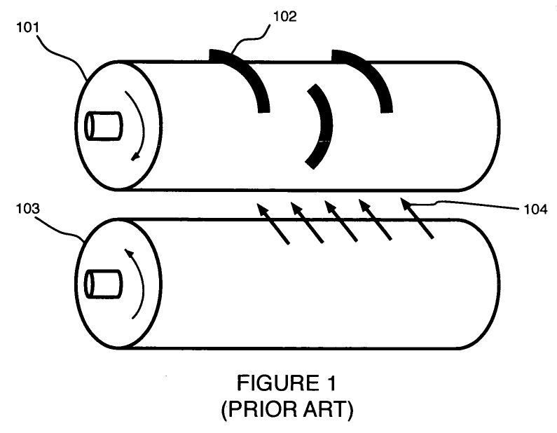

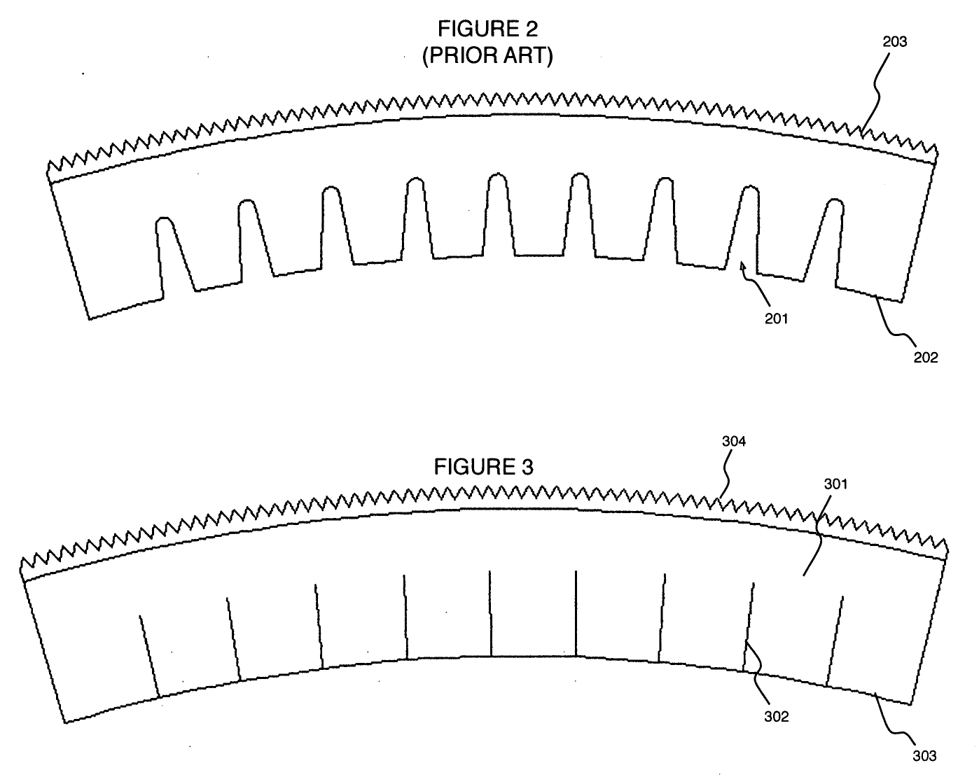

### DETAILED DESCRIPTION OF PREFERRED EMBODIMENTS

According to an embodiment of the present disclosure, a curved rule stock 301 for cutting and/or perforating blank material includes markings 302 disposed on a side of the curved rule 301 and a backside edge 303. The backside edge 303 is opposite a cutting edge 304. The markings 302 may be disposed, e.g., printed or scored, on the side of the curved rule 301 at regular intervals forming a reference pattern (see FIG. 3).

The markings 302 disposed at regular intervals facilitate fast measurement of the curved rule stock 301 for manufacturing a spool of curved rule into a cutting tool for a rotary cutting die machine. The markings 302 may be disposed on the side of the curved rule stock 301 and/or on the backside 303 of the curved rule 301.

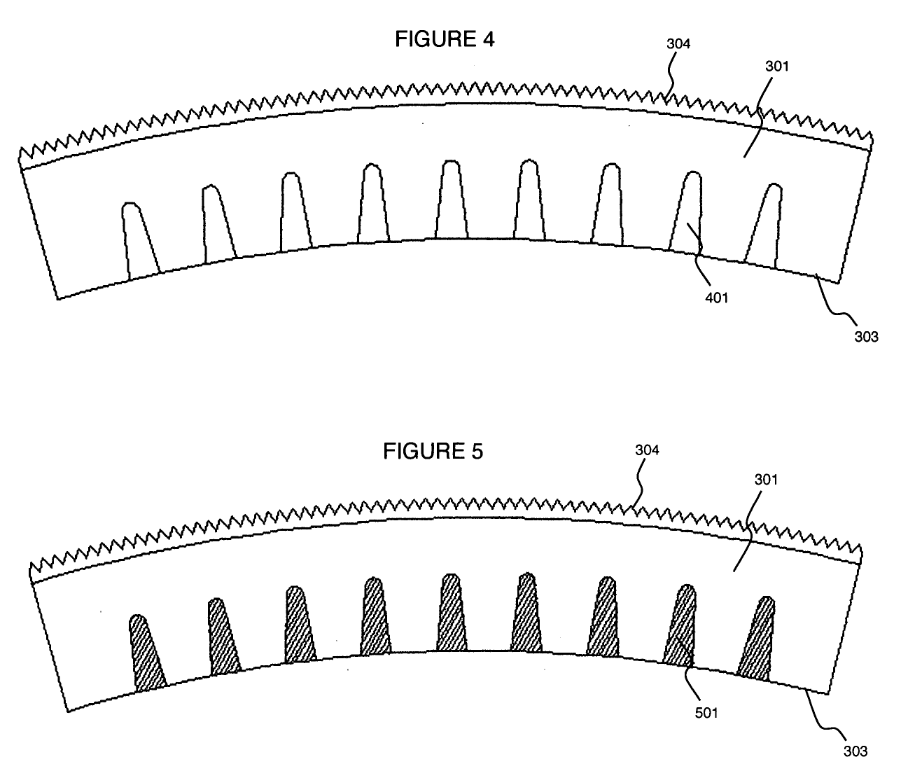

The markings 401/501 may substantially mimic existing notch configurations, either as an outline 401 or a filled marking 501 (see FIGS. 4 and 5). The markings 401/501 may be formed by ink printing, burnishing, etching, and the like.

Since the curved rule stock 301 is not physically pre-notched, the cost of manufacturing the curved rule stock 301 can be substantially reduced. One of ordinary skill in the art would appreciate that the curved rule stock 301 or curved rule formed therefrom may be selectively notched, bent, and cut by a die maker, for example, to form a bridge notch, wherein the die maker can make use of the markings in preparing the curved rule for attachment to the die board.

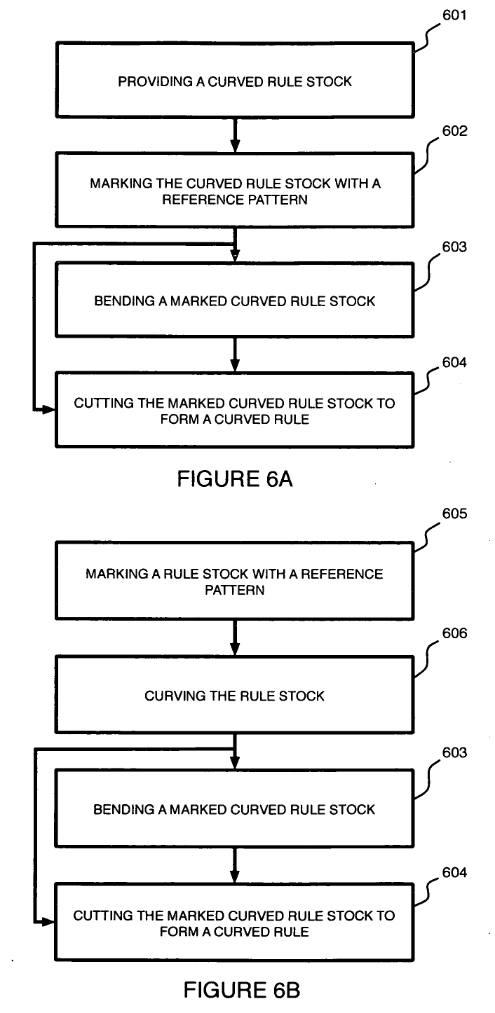

Referring to FIG. 6A, a method for forming the curved rule includes providing a curved rule stock 601, and marking a side of the curved rule stock with a reference pattern to form a marked curved rule stock 602. The method includes bending the marked curved rule stock 603 and cutting the marked curved rule stock to form the curved rule for attachment to a die board, 604 wherein the marked curved rule stock is not notched.

While the marking of the curved rule has been described as being performed on curved rule, one of ordinary skill in the art would appreciate that rule stock may be marked prior to a curving of the rule stock. Referring to FIG. 6B, for example, a rule stock may be marked 605 and subsequently curved 606, prior to processing, which may include bending 603 and/or cutting 604.

When used in an automatic bending machine, which may also perform a cutting process, no-notch curved rule according to an embodiment of the present disclosure can be bent consistently while imparting prolonged tool life as the machine or operator has control of where to put any notches (e.g., relief notches or bridge notches), and further the no-notch curved rule is less prone to jamming the bending machine. Further still, no-notch curved rule results in a stronger die as the bending machine or die maker puts the notches only where needed.

According to an embodiment of the present disclosure, a no-notch curved rule including markings enables efficient manual bending and cutting operation through providing visual references as to where cuts and/or bending should happen. Thus, the die maker need not rely on a tape ruler on a curved rule, which is time consuming and likely to result in measuring error.

It should be appreciated that while the curved rule 301 has been described as a cutting tool, it may also be a creasing or scoring knife or other non-cutting rule.

Having described embodiments for a curved rule for a rotary cutting die machine, it is noted that modifications and variations can be made by persons skilled in the art in light of the above teachings. It is therefore to be understood that changes may be made in embodiments of the present disclosure that are within the scope and spirit thereof.

What is claimed is:

1. A curved rule of a rotary cutting die comprising:
a cutting edge;
a backside edge opposite the cutting edge; and
a plurality of markings disposed on a side of the curved rule.

2. The curved rule of claim 1, wherein the plurality of markings are disposed on more than one side of the curved rule.

3. The curved rule of claim 1, wherein the plurality of markings are disposed on the backside edge of the curved rule.

4. The curved rule of claim 1, wherein the plurality of markings are printed on the curved rule.

5. The curved rule of claim 1, wherein the plurality of markings are scored on the curved rule.

6. The curved rule of claim 1, wherein the plurality of markings are disposed in a known pattern.

7. The curved rule of claim 1, wherein the backside comprises a continuous length with no notches.

8. A method of manufacturing a curved rule stock, comprising:
providing a rule stock;
marking a side of the rule stock with a reference pattern to form a marked rule stock; and
curving the marked rule stock to form the curved rule stock.

9. The method of claim 8, wherein marking comprises scoring the side of the rule stock.

10. The method of claim 8, wherein marking comprises printing a pattern on the side of the rule stock.

11. The method of claim 8, further comprising bending the marked curved rule stock.

12. The method of claim 11, further comprising cutting the marked curved rule stock to form the curved rule for attachment to a die board, wherein the marked curved rule stock is not notched.
